(19) United States
(12) Patent Application Publication
(10) Pub. No.: US 2003/0006015 A1
(43) Pub. Date: Jan. 9, 2003

(54) Sunshade capable of decomposing air contaminants

(76) Inventor: Paul Lin, Yung-Kang City (TW)

Correspondence Address: Ladas & Parry, Suite 1200, 224 South Michigan Avenue, Chicago, IL, 60604, US

(21) Appl. No.: 09/900,315

(22) Filed: Jul. 6, 2001

(51) Int. Cl. B60J 1/20

(52) U.S. Cl. 160/370.23

(57) ABSTRACT

A sunshade has a sunshade body with a front side adapted to face a light source, and a rear side opposite to the front side. A light-catalytic coating layer is provided on at least one of the front side and the rear side, and includes a light-activable catalyst capable of oxidizing and decomposing air contaminants.

### BACKGROUND OF THE INVENTION

1. Field of the Invention

The invention relates to a sunshade, more particularly to a sunshade capable of decomposing air contaminants via a light-catalytic oxidation reaction.

2. Description of the Related Art

In the design of a building or a vehicle, generally, glass windows are provided at appropriate locations of the building or the vehicle, so as to achieve the purpose of ventilation and brightness. In order to prevent sunlight from irradiating the interior of buildings or vehicles, sunshades are usually provided at the vicinity of the windows. Although the conventional sunshade can provide the function of shading from sunlight, air will be conducted between the inside and the outside of building or vehicle when the window is open.

In addition to essential components (such as nitrogen, oxygen, water etc.), air also includes other substances, such as, dust, oil particles, ammonia, sulfur dioxide, and germs (for example, mould, escherichia coli etc.). The substances, such as dust, oil particles and germs, are harmful to human bodies, and the substances, such as ammonia and sulfur dioxide will create foul odor.

### SUMMARY OF THE INVENTION

Therefore, the object of the present invention is to provide a sunshade capable of decomposing air contaminants.

The sunshade according to this invention comprises a sunshade body and a light-catalytic coating layer. The sunshade body has a front side adapted to face a light source, and a rear side opposite to the front side. The light-catalytic coating layer is provided on at least one of the front side and the rear side, and comprises a light-activable catalyst capable of oxidizing and decomposing air contaminants.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing the relationship between the window of a vehicle and the preferred embodiment of the sunshade according to this invention;

FIG. 2 is a schematic top view showing the relationship between the window of a vehicle and the preferred embodiment of the sunshade according to this invention;

FIG. 3 is a magnified sectional view showing the relationship between the window of a vehicle and the preferred embodiment of the sunshade according to this invention;

FIG. 4 is a schematic view showing the reaction of a light-catalytic coating layer of the sunshade according to this invention when the sunshade is irradiated by a light source;

FIG. 5 is a perspective view showing the relationship between the window of a vehicle and an another preferred embodiment of the sunshade according to this invention; and

FIG. 6 is a perspective view of yet another preferred embodiment of the sunshade according to this invention.

### DETAILED DESCRIPTION OF THE PREFERRED EMBODIMENTS

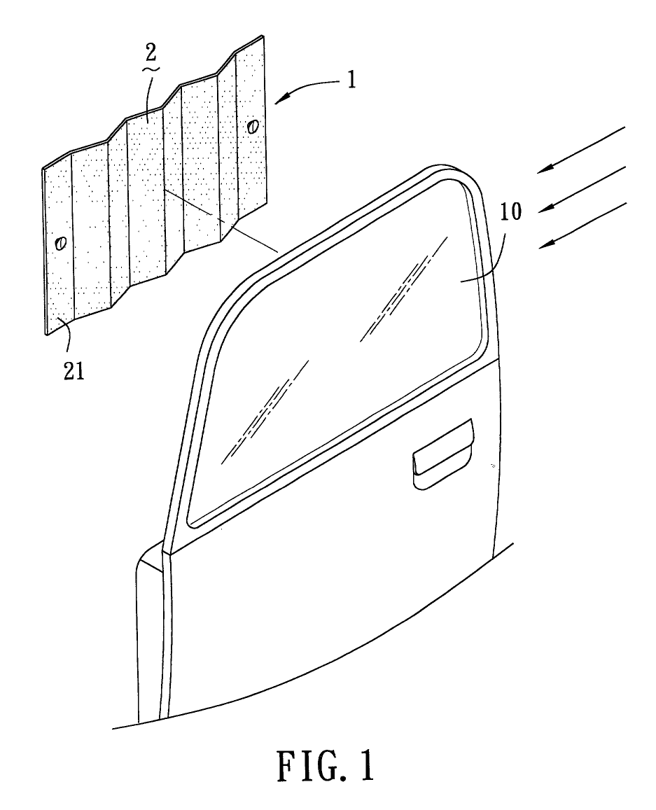

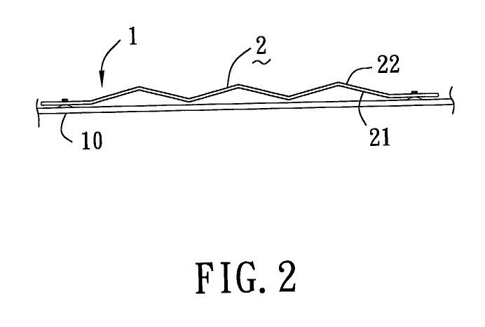

Referring to FIGS. 1 and 2, the sunshade 1 of the preferred embodiment of this invention could be installed on a glass window 10 of a vehicle. It could also be hung on the inside of a glass window of a building. The sunshade 1 comprises a sunshade body 2 and a light-catalytic coating layer 3.

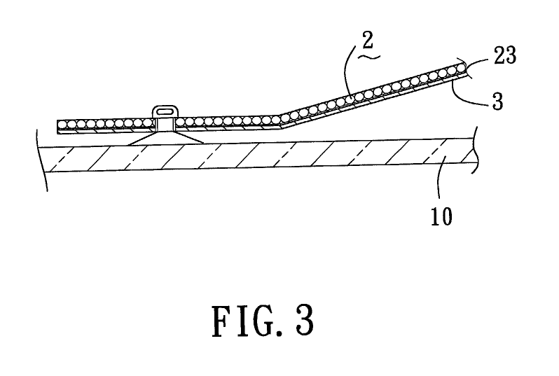

Referring to FIGS. 2 and 3, the sunshade body 2 has a front side 21 adapted to face a light source (such as, sunlight), and a rear side 22 opposite to the front side 21. In this embodiment, the sunshade body 2 is constructed from a foam material. A reflective layer 23, which is composed of a reflective material (such as, metal material, for example, aluminum foil), is provided on the front side 21 of the sunshade body 2. Therefore, the irradiation of the light source could be reflected by the reflective layer 23.

The light-catalytic coating layer 3 is provided on the reflective layer 23, and comprises a light-activable catalyst, such as titanium dioxide, for oxidizing and decomposing air contaminants. The light-catalytic coating layer 3 could be provided on the reflective layer 23 by any suitable methods known in the art. For example, the light-activable catalyst can be dissolved or suspended into a suitable solvent (such as, resin), and then coated on the reflective layer 23, so as to form the light-catalytic coating layer 3 on the reflective layer 23 when dried.

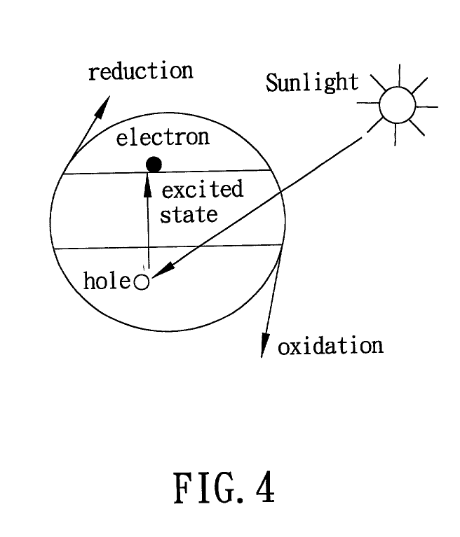

Referring to FIG. 4, when the light-catalytic coating layer 3 is irradiated by a light source (such as, sunlight), the electrons in the light-activable catalyst (i.e., titanium dioxide) of the light-catalytic coating layer 3 are excited to formholes with positive charges. The holes have strong oxidizing capability so as to oxidize and decompose harmful contaminants in air.

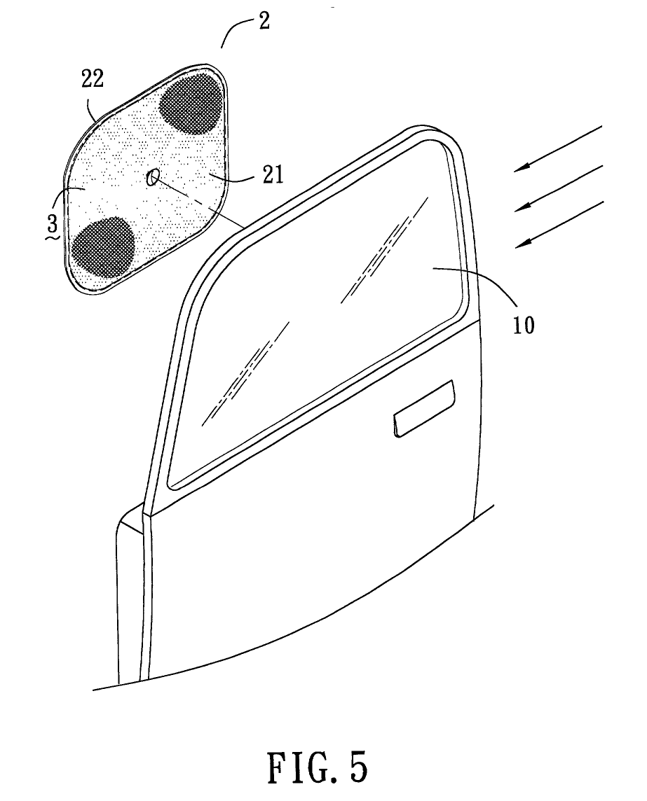

Referring to FIG. 5, in an another preferred embodiment of the sunshade according this invention, the sunshade body 2 is in the form of a web cloth and is usually installed on the window of a vehicle. The sunshade body 2 has a front side 21 adapted to face a light source, and a rear side 22 opposite to the front side 21. A light-catalytic coating layer 3 is provided on the front side 21 of the sunshade body 2. Therefore, when the light-catalytic coating layer 3 is irradiated by a light source, it can result in the aforesaid oxidation reaction, so as to achieve the effect of oxidizing and decomposing the air contaminants.

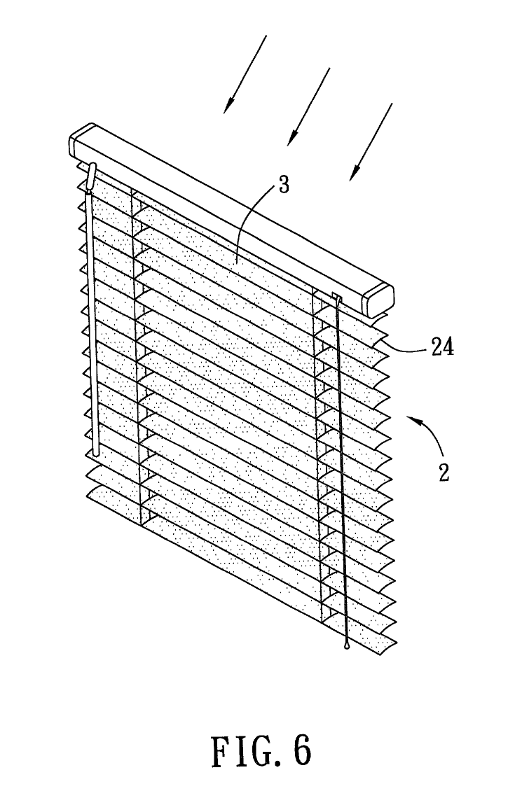

FIG. 6 shows yet another preferred embodiment of the sunshade according to this invention. The sunshade body 2 of this preferred embodiment is in the form of blind slats 24. The light-catalytic coating layer 3 is provided on all of the blind slats 24 of the sunshade body 2. Similarly, when the light-catalytic coating layer 3 is irradiated by a light source, it can result in the aforesaid oxidation reaction, so as to achieve the effect of oxidizing and decomposing the air contaminants.

Since the rear side 22 of the sunshade body 2 can also be irradiated by a light source, the light-catalytic coating layer 3 could also be provided on the rear side 22 of the sunshade body 2 to achieve the desired effect of this invention.

In view of the aforesaid, the sunshade of this invention can achieve an improvement over the prior art. Additionally, the sunshade of this invention also has the following advantages:

1. an effect of killing germs: harmful germs present in the air (such as, mould, escherichia coli, staphylococcus etc.) could be killed;

2. an effect of de-odorizing: foul odor attributed to substances, such as ammonia, sulfurdioxide, toluene, methyl aldehyde, ethyl aldehyde formic acid, phenol, nicotine etc., can be eliminated;

3. strong oxidizing capability: organic materials (such as, oil particles and dirt) can be decomposed so as not to accumulate on the surface of the sunshade;

4. non-use of toxic substances: the light-catalytic coating layer 3 is not harmful to the environment;

5. low energy to activate the light-catalytic oxidation reaction: an energy of only about 0.1 W is required to excite the light-catalytic coating layer 3; and

6. a long service life: the light-catalytic coating layer 3 is not consumed upon use.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A sunshade capable of decomposing air contaminants, comprising:
a sunshade body having a front side adapted to face a light source, and a rear side opposite to said front side; and
a light-catalytic coating layer, which is provided on at least one of said front side and said rear side and which comprises a light-activable catalyst capable of oxidizing and decomposing the air contaminants.

2. The sunshade of claim 1, wherein said light-activable catalyst is titanium dioxide.

3. The sunshade of claim 2, further comprising a light-reflective layer, which is interposed between said front side and said light-catalytic coating layer, said sunshade body being formed as a corrugated sheet.

4. The sunshade of claim 2, wherein said sunshade body is formed as a plurality of blind slats.

5. The sunshade of claim 4, wherein said light-catalytic coating layer is provided on said blind slats at said front and rear sides.
